(19) United States
(12) Patent Application Publication
(10) Pub. No.: US 2026/0293808 A1
(43) Pub. Date: Oct. 1, 2026

(54) MOWING APPARATUS

(71) Applicant: Lawnix Technology (Nanjing) Co., Ltd., Nanjing (CN)

(72) Inventor: Xiaoke Zou, Nanjing (CN)

(21) Appl. No.: 19/630,628

(22) Filed: Mar. 27, 2026

(30) Foreign Application Priority Data
Mar. 30, 2025 (CN) 202520581583.5
May 15, 2025 (CN) 202510630974.6
Jun. 23, 2025 (CN) 202510845731.4

(51) Int. Cl. A01D 43/077; A01D 34/68; A01D 101/00

(52) U.S. Cl. CPC A01D 43/077; A01D 34/68; A01D 2101/00

(57) ABSTRACT

Disclosed herein is a mowing apparatus, including: a housing assembly with an air inlet open to outside, a grass-discharge channel, and a cutting cavity fluidly connected to both the air inlet and the grass-discharge channel, where an end of the grass-discharge channel away from the cutting cavity forms a grass-discharge outlet open to outside; a cutting assembly disposed, the cutting assembly including a first motor and a cutting blade coupled to the first motor, where rotation of the cutting blade generates a first airflow, the first airflow flows into the grass-discharge channel through the cutting cavity, and exits through the grass-discharge outlet; and a second motor and an impeller disposed adjacent to the grass-discharge outlet, where the second motor is operatively coupled to the impeller, rotation of the impeller generates a supplemental airflow, and the supplemental airflow flows past the impeller and exits through the grass-discharge outlet.

### CROSS-REFERENCE TO RELATED APPLICATIONS

This application claims priority to the following Chinese patent applications, the entire contents of each of which are hereby incorporated by reference into the present application: Chinese Patent Application No. 202510845731.4, filed on Jun. 23, 2025; Chinese Patent Application No. 202520581583.5, filed on Mar. 30, 2025; Chinese Patent Application No. 202510630974.6, filed on May 15, 2025.

### TECHNICAL FIELD

This present disclosure relates to mowing apparatuses and, in particular, to a mowing apparatus.

### BACKGROUND

Currently, when a mowing apparatus performs cutting under high-load or wet grass conditions, the amount of grass clippings may accumulate within the air duct of the mowing apparatus, or may increase their weight(due to the grass becoming wet).

### SUMMARY

According to some embodiments of the present disclosure, a mowing apparatus is provided. The mowing apparatus includes a housing assembly defining a cutting cavity and a grass-discharge channel, a cutting assembly disposed within the cutting cavity, and an air supplement assembly. In some embodiments, the cutting assembly includes a first motor and a cutting blade driven by the first motor. Rotation of the cutting blade generates a first airflow flowing from an air inlet through the cutting cavity and into the grass-discharge channel. In some embodiments, the air supplement assembly includes a second motor and an impeller disposed adjacent to a discharge outlet of the grass-discharge channel. The impeller is rotatable to generate a supplemental airflow, and the supplemental airflow is directed toward the discharge outlet. In some embodiments, the supplemental airflow merges with the first airflow within the grass-discharge channel to facilitate discharge of cut grass. In some embodiments, flow paths of the first airflow and the supplemental airflow are at least partially separated upstream of a merging location.

### BRIEF DESCRIPTION OF THE DRAWINGS

To explain the technical solutions in the embodiments of this disclosure or in the prior art more clearly, the accompanying drawings required for illustrating the embodiments or the prior art will be briefly introduced below. Apparently, the accompanying drawings in the following description show merely some embodiments of this disclosure, and a person of ordinary skill in the art may derive other drawings from these accompanying drawings without making creative efforts.

FIG. 1 is a schematic diagram of an overall structure of a mowing apparatus according to an embodiment;

FIG. 2 is a schematic diagram of an internal structure of the mowing apparatus according to an embodiment;

FIG. 3 is an enlarged view of a partial structure in FIG. 2;

FIG. 4 is a schematic structural diagram of a housing assembly from one perspective according to an embodiment;

FIG. 5 is a schematic structural diagram of the housing assembly from another perspective according to an embodiment;

FIG. 6 is a schematic structural diagram of a cutting housing assembly from one perspective according to an embodiment;

FIG. 7 is a schematic structural diagram of the cutting housing assembly from another perspective according to an embodiment;

FIG. 8 is a schematic structural diagram of a supplemental air housing according to an embodiment;

FIG. 9 is a schematic structural diagram of an air guiding housing according to an embodiment;

FIG. 10 is a schematic diagram illustrating a flow direction of a first airflow a according to an embodiment;

FIG. 11 is a schematic diagram illustrating a flow direction of a second airflow b according to an embodiment;

FIG. 12 is a schematic diagram illustrating a flow direction of a third airflow c according to an embodiment; and

FIG. 13 is a schematic structural diagram of a heat dissipation outlet according to an embodiment.

### REFERENCE SIGNS USED IN THE ABOVE FIGURES

1: mowing apparatus;

10: housing assembly; 11: air inlet; 12: grass-discharge channel; 121: grass-discharge outlet; 13: cutting cavity;

14: mounting housing assembly; 141: mounting cavity; 142: first connecting opening; 143: second connecting opening; 144: connecting portion; 1441: support plate; 1442: connection plate; 14421: fourth connecting opening;

15: cutting housing assembly; 151: third connecting opening;

16: supplemental air housing; 161: supplemental air channel; 1611: supplemental air inlet; 1612: supplemental air outlet; 162: first positioning member;

17: positioning housing; 171: positioning groove;

18: air guiding groove;

20: cutting assembly; 21: first motor; 22: cutting blade;

31: second motor; 32: impeller;

40: heat-generating component;

41: battery pack; 411: heat dissipation inlet; 412: heat dissipation outlet;

42: control module;

50: flow guiding member; 51: flow guiding surface;

60: air guiding housing; 61: air guiding channel; 62: air guiding outlet; 63: air guiding inlet;

70: air intake grille;

80: battery compartment; and

90: grass collection basket.

### DETAILED DESCRIPTION OF THE EMBODIMENTS

To make the purposes, technical solutions, and advantages of the embodiments of this disclosure clearer, the technical solutions in the embodiments of this disclosure will be described clearly and completely below with reference to the accompanying drawings in the embodiments of this disclosure. Apparently, the described embodiments are some but not all of the embodiments of this disclosure. The assemblies of the embodiments of this disclosure, which are generally described and illustrated in the accompanying drawings herein, may be arranged and designed in various different configurations.

Therefore, the following detailed description of the embodiments of this disclosure provided in the accompanying drawings is not intended to limit the claimed scope of protection of this disclosure but merely represents selected embodiments of this disclosure. Based on the embodiments of this disclosure, all other embodiments obtained by a person of ordinary skill in the art without making creative efforts shall fall within the scope of protection of this disclosure.

It should be noted that similar reference signs and letters denote similar items in the following accompanying drawings. Therefore, once an item is defined in one accompanying drawing, it does not require further definition and explanation in subsequent accompanying drawings.

In the description of the embodiments of this disclosure, it should be understood that the orientations or positional relationships indicated by the terms “center”, “upper”, “lower”, “left”, “right”, “vertical”, “horizontal”, “inner”, “outer”, etc., are based on those shown in the accompanying drawings, or refer to those typically employed by a product of this disclosure during use, or refer to those commonly understood by those skilled in the art. These terms are used merely for the convenience of describing this disclosure and simplifying the description rather than for indicating or implying that the referred apparatus or element must have a specific orientation or be constructed and operated in a specific orientation. Therefore, they should not be construed as limitations on this disclosure.

In the description of the embodiments of this disclosure, it should also be noted that, unless otherwise expressly specified and defined, the terms “disposed”, “installed”, “connected”, and “attached” should be interpreted in a broad sense. For example, they may refer to fixed connections, detachable connections, or integral connections; they may refer to direct connections or indirect connections through an intermediate medium; or they may refer to internal communication between two elements. For a person of ordinary skill in the art, the specific meanings of the above terms in this disclosure may be understood based on the specific context.

In the description of the embodiments of this disclosure, it should also be noted that the terms such as “first” and “second” used herein do not denote any particular order or sequence, nor are they intended to limit this disclosure; they are used merely to distinguish assemblies or operations described with the same technical terms.

It should be noted that the embodiments of this disclosure and the features of the embodiments may be combined with each other in case of no conflict.

The technical solutions of this disclosure will be described below with reference to the accompanying drawings.

In some cases, a flow resistance of the airflow generated by the rotation of the mowing apparatus’ blade becomes greater, leading to a reduction in the grass-discharge flow velocity of the grass clippings. This results in decreased cutting efficiency within the air duct, diminished the grass-discharge capacity at the grass-discharge outlet, and further reduces the fill rate of the grass collection basket, requiring users to frequently clean the grass clippings from the grass collection basket. This not only increases inconvenience for users but also reduces work efficiency.

To address the issue of low grass-discharge flow velocity in existing mowing apparatuses, this disclosure provides a mowing apparatus. The mowing apparatus primarily includes six major functional modules. The power module (an engine or motor and its associated energy system) serves as the core, providing the original driving force. Its output shaft is directly connected to the transmission module via a coupling or clutch. The transmission module (including a main shaft, clutch, belt/chain, gearbox, etc.) is responsible for power distribution and transmission: in one aspect, it drives the blade of the cutting module to rotate at high speed for mowing through a rigid shaft or belt; in another aspect (in self-propelled models), it transmits power to the wheel axle of the walking/chassis module via a chain or drive shaft to propel the entire machine. The walking/chassis module (including a frame, height-adjustable wheel set, and handle) constitutes the skeleton and support of the entire machine. The chassis is fixed and carries all the other modules; the walking wheels are hinged to the chassis via wheel axles and driven by the transmission module, while the handle is equipped with control elements. The control and safety module (including switches, a throttle, a clutch/self-propelled control lever, an emergency stop device, and wiring harnesses) is concentrated on the handle, connecting and regulating the power module (e.g., start/stop, speed adjustment), transmission module (e.g., clutch engagement/disengagement, walking drive), and cutting module via mechanical cables or electrical circuits to ensure safe operation. The protection and grass-collection module (including a cutting disc guard, grass-discharge outlet, grass collection basket, and muffler) is directly integrated around the cutting blade of the cutting assembly or at the exhaust port of the power module to protect personnel safety, manage grass clippings, and reduce noise. Each module is integrated into an efficient and safe overall system on the chassis through mechanical fastening, shaft connection, belt driving, wiring harness interconnection, and other means.

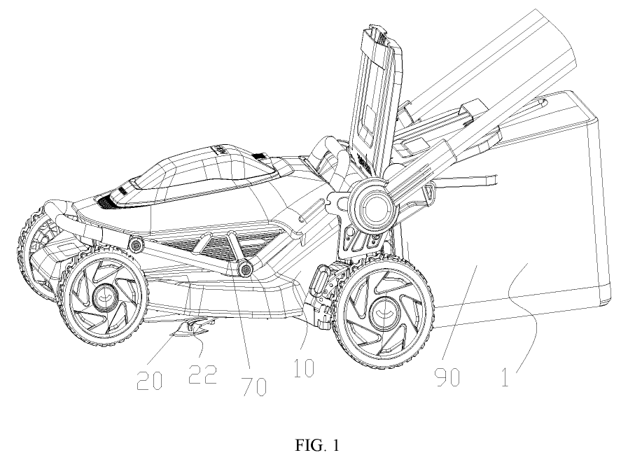

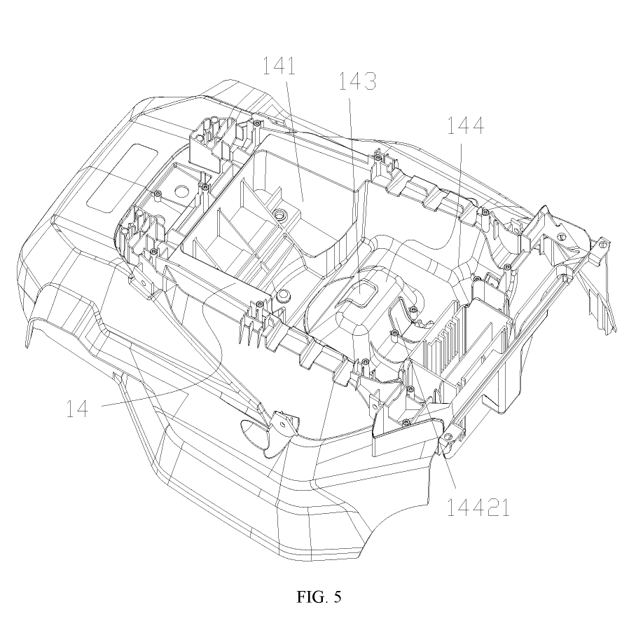

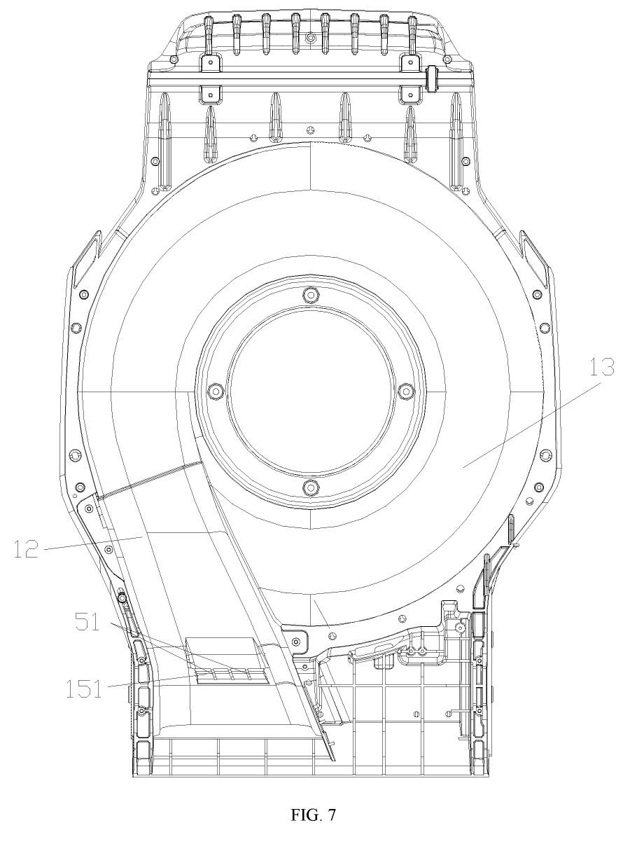

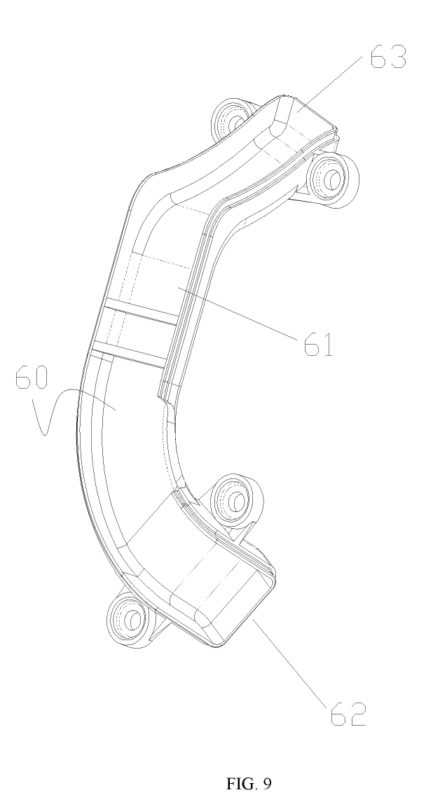

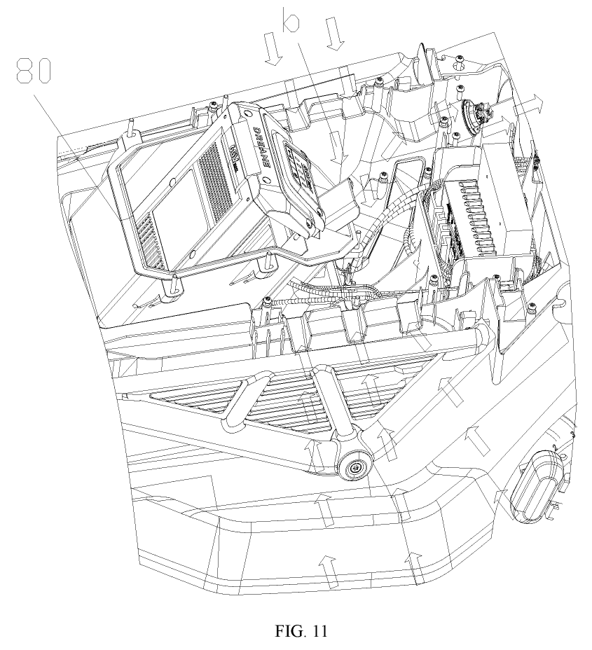

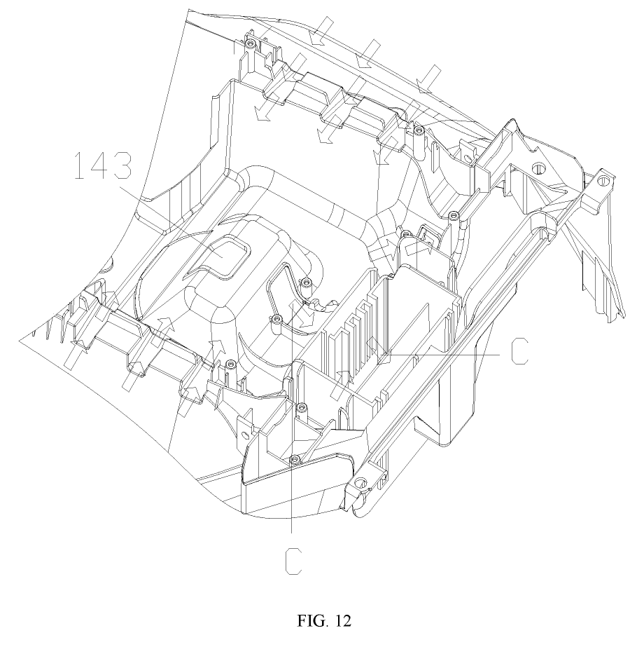

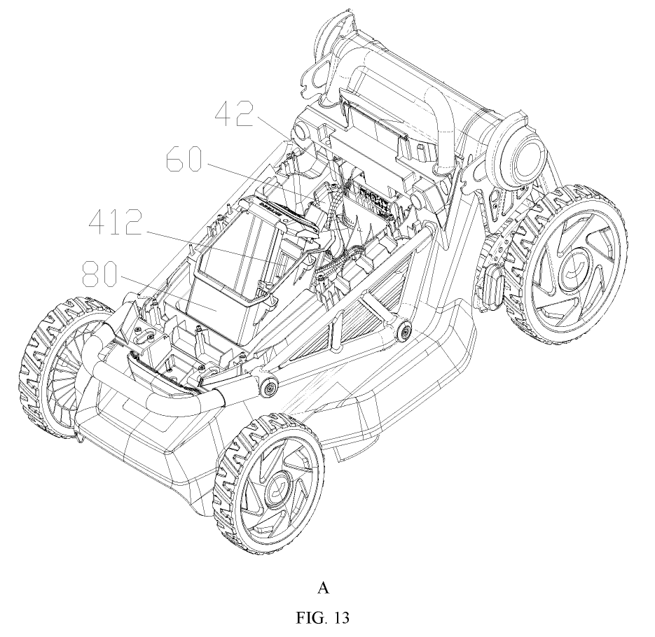

As shown in FIGS. 1-13, this disclosure provides a mowing apparatus 1, including: a housing assembly 10, a cutting assembly 20, a second motor 31, and an impeller 32, where the housing assembly 10 includes an air inlet 11 open to outside (external environment), a grass- discharge channel 12, and a cutting cavity 13 fluidly connected to both the air inlet 11 and the grass-discharge channel 12, and an end of the grass-discharge channel 12 away from the cutting cavity 13 forms a grass-discharge outlet 121 open to outside. The cutting assembly 20 is disposed within the cutting cavity 13, including a first motor 21 and a cutting blade 22 coupled to the first motor 21, where rotation of the cutting blade 22 generates a first airflow, the first airflow flows into the grass-discharge channel 12 through the cutting cavity 13, and exits through the grass-discharge outlet 121. The grass-discharge outlet 121 also allows a supplemental airflow flowing through the housing assembly 10 to pass through, the supplemental airflow and the first airflow a converge at a preset position, and paths of the supplemental airflow and the first airflow a are at least partially different upstream of a convergence point. In some embodiments, the preset position is upstream of the grass-discharge outlet 121, meaning that the supplemental airflow and the first airflow a first converge before entering the grass-discharge outlet 121 and are then discharged together. Certainly, as an alternative embodiment, the preset position may also be disposed at the grass-discharge outlet 121, meaning that the first airflow a and the supplemental airflow converge and are discharged at the grass-discharge outlet 121. The convergence point is not limited herein. The mowing apparatus enables the supplemental airflow to no longer act only at the grass-discharge outlet but instead converges with the first airflow at the preset position, enhancing the airflow rate at the grass-discharge outlet under the combined action of the two airflows: by converging in advance at the preset position, the first airflow can be reinforced and rectified earlier, which helps increase the overall airflow velocity and carrying capacity within the grass-discharge channel, reduces the probability of grass clippings lingering midway in the grass-discharge channel, improves the continuity and smoothness of the grass-discharge process, and contributes to mitigating grass-discharge instability issues caused by backflow or local accumulation of grass clippings.

The second motor 31 is operatively coupled to the impeller 32. The second motor 31 and the impeller 32 are disposed adjacent to the grass-discharge outlet. The second motor 31 drives the impeller 32 to rotate, then rotation of the impeller 32 generates a supplemental airflow flowing past the impeller 32, and an outlet side of a supplemental air channel is fluidly connected to the grass-discharge outlet 121 to enhance an airflow rate at the grass-discharge outlet 121 under the action of the supplemental airflow. This configuration enables the second motor to drive the impeller to rotate, thereby generating the supplemental airflow flowing past the impeller, while the outlet side of the supplemental airflow communicates with the grass-discharge outlet, enabling the supplemental airflow to effectively enhance the airflow rate at the grass-discharge outlet. This can facilitate the efficient and rapid discharge of grass clippings at the grass-discharge outlet to the outside of the housing, thereby increasing the grass-discharge flow velocity at the grass-discharge outlet.

Using the mowing apparatus 1 provided in some embodiments, by adding the second motor 31 and the impeller 32, when the second motor 31 is activated, it drives the impeller 32 to rotate and generate the supplemental airflow flowing past the impeller 32. By directing the supplemental airflow to the grass-discharge outlet 121 open to outside, the airflow rate at the grass-discharge outlet 121 can be effectively enhanced. This facilitates the efficient and rapid discharge of grass clippings at the grass-discharge outlet 121 to the outside. In some embodiments the grass clippings at the grass-discharge outlet 121 can be discharged into a grass collection basket, thereby increasing the flow velocity at the grass-discharge outlet 121. This prevents the concentration and accumulation of grass clippings at the grass-discharge outlet 121, ensures smooth grass discharge, facilitates the collection of grass clippings by the grass collection basket, and also avoids affecting the normal cutting operation of the cutting assembly within the cutting cavity 13 due to grass clippings accumulating at the grass-discharge outlet 121. Therefore, the mowing apparatus 1 provided in some embodiments can address the issue of low grass-discharge flow velocity for grass clippings in existing mowing apparatuses 1.

In some embodiments, a high-speed airflow generated by a fan is utilized to enhance the grass-discharge capacity at the grass-discharge outlet 121, solving the problem of poor grass clipping flow under high-load or wet grass conditions, significantly improving grass-discharge efficiency, and reducing the frequency of cleaning grass clippings by users. In the grass collection mode of the mowing apparatus, it can notably increase the collection capacity of the grass collection basket.

The application scenarios in some embodiments primarily involve garden maintenance, pasture management, and other occasions requiring efficient mowing operations.

Using the mowing apparatus 1 provided in some embodiments, the specific working process includes: during the mowing operation, the second motor 31 automatically starts or is activated under specific conditions.

In some embodiments, the mowing apparatus 1 further includes: a heat-generating component 40 installed inside the housing assembly 10, where the heat-generating component 40 is located on at least one flow path of the first airflow a and the supplemental airflow, and at least a portion of the supplemental airflow flows past the heat-generating component 40 and is then discharged through the grass-discharge outlet 121.

The heat-generating component 40 in some embodiments includes at least one of a battery pack 41 and a control module 42. In some embodiments, the battery pack 41 is located on paths of the first airflow a and the supplemental airflow; and the control module 42 is located on the path of the supplemental airflow. Certainly, the battery pack 41 and the control module 42 may also be located on all flow paths of the first airflow a and the supplemental airflow, which is not limited herein, provided that at least one airflow flows past the battery pack 41 or the control module 42 for heat dissipation.

In some embodiments, a mounting space where the heat-generating component 40 is located communicates with an inlet side of the supplemental airflow, so that rotation of the impeller 32 generates the supplemental airflow flowing past the heat-generating component 40 and converging into the first airflow a. This structural configuration facilitates carrying away at least a portion of the heat generated by the heat-generating component 40 inside the mowing apparatus 1 via the supplemental airflow, thereby effectively allowing the heat generated by the heat-generating component 40 to converge into the first airflow a via the supplemental airflow and be discharged to the grass-discharge outlet 121 along with the first airflow a, and finally be discharged out through the grass-discharge outlet 121, consequently facilitating heat dissipation for the heat-generating component 40.

Furthermore, in some embodiments, the supplemental airflow generated through the impeller 32 includes a second airflow b and a third airflow c. On the one hand, at least one of the second airflow b and the third airflow c achieves heat dissipation for the heat-generating component 40; on the other hand, the airflow rate at the grass-discharge outlet 121 can be effectively increased and the grass-discharge speed at the grass-discharge outlet 121 can be improved. In the grass collection mode of the mowing apparatus, this facilitates rapid collection of grass clippings by the grass collection basket.

In some embodiments, the second airflow b flows past the battery pack 41, and the third airflow c flows past the control module 42. Certainly, the second airflow b and the third airflow c may also be provided to flow through both the battery pack 41 and the control module 42, which is not limited herein, provided that at least one airflow achieves heat dissipation for the battery pack 41 or the control module 42.

When the heat-generating component 40 includes one of the battery pack 41 and the control module 42, any one or more of the second airflow b and the third airflow c achieve heat dissipation for the heat-generating component 40; when the heat-generating component 40 includes both the battery pack 41 and the control module 42, the second airflow b and the third airflow c may be provided to achieve heat dissipation for the battery pack 41 and the control module 42, respectively, meaning that the second airflow b and the third airflow c flow past the battery pack 41 and the control module 42, respectively, and then flow out from the grass-discharge outlet 121; or, the second airflow b and the third airflow c are provided to achieve heat dissipation for the battery pack 41 and the control module 42 simultaneously, meaning that both the second airflow b and the third airflow c flow past the battery pack 41 and the control module 42. For example, the mowing apparatus further includes a battery compartment 80 configured to a detachably receive the battery pack 41, and the second airflow flows through the battery compartment 80. The mowing apparatus further includes a positioning housing 17 configured to receive the control module 42, and the third airflow flows through the positioning housing 17.

Certainly, the aforementioned heat-generating component 40 is not limited to the battery pack 41 and the control module 42, and may also include one or more of the following:

I. a motor, or one or more components thereof, such as a stator, a rotor, or brushes;

II. a transmission assembly, or one or more related components thereof, such as a gearbox, a drive shaft/coupling, or a clutch; and

III. other electrical and auxiliary components, such as power connections and interfaces, lighting and indicator components, sensors, active heating elements, braking resistors, or electromagnets/solenoids.

It is understandable that components that easily generate heat during operation due to physical friction or electrical resistance losses (or losses from switches, magnetic cores, dielectrics, etc.) of electronic components can be considered as the aforementioned heat-generating component 40, and heat dissipation is achieved through the configuration described above.

In some embodiments, when the heat-generating component 40 includes a battery pack 41, the mounting cavity 141, where the battery pack 41 is disposed, is fluidly connected to the cutting cavity 13, and the battery pack 41 is located on flow paths of the first airflow a and the second airflow b. This configuration enables the heat generated by the battery pack 41 to be carried away to the grass-discharge outlet 121 by both the first airflow a and the second airflow b. The battery pack 41 can be directly cooled by the first airflow a or by the second airflow b. This configuration can improve the heat dissipation efficiency of the battery pack without altering the flow direction of the first airflow a, thereby preventing severe overheating of the battery pack.

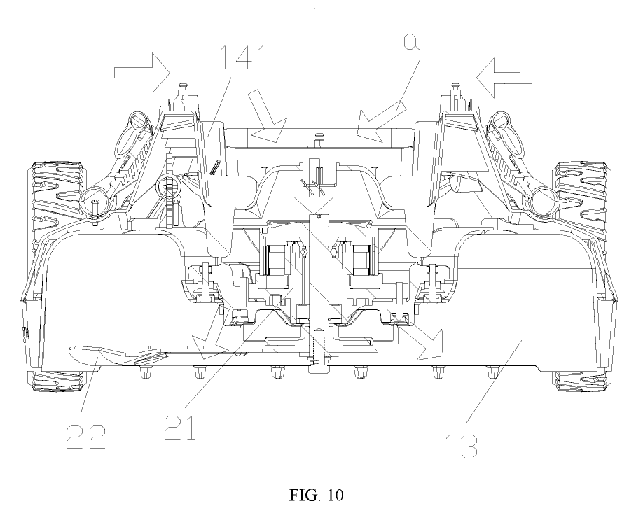

As shown in FIG. 10, in the mowing apparatus 1 provided in some embodiments, the first airflow a generated by the rotation of the cutting assembly propels grass clippings for discharge while carrying away the heat generated by the battery pack 41, achieving a dual effect. Moreover, as the first airflow flows past the first motor 21, it can also effectively carry away the heat generated by the operation of the first motor 21. Therefore, this configuration not only improves the grass-discharge efficiency but also enhances the heat dissipation capability of the apparatus, effectively maintaining the apparatus’s normal operating temperature during continuous high-intensity operations. During prolonged mowing operations, such as the maintenance of large lawns, when the apparatus is in operation, the first airflow a generated by the cutting assembly passes through the cutting space and the grass-discharge channel 12 to reach the grass-discharge outlet 121, accelerating the discharge of grass clippings from the grass-discharge outlet 121 while simultaneously removing heat generated by the battery pack 41.

The above configuration utilizes the second airflow b flowing past the battery pack 41 for natural cooling, while guiding this portion of heat away from the battery pack 41 toward the impeller 32. This achieves effective heat dissipation of the battery pack 41 and fully utilizes the thermal energy, serving to dry wet grass and avoiding energy waste. Drying the grass reduces its weight after accumulation, lessens the overall weight of the machine, and makes pushing easier. The described configuration improves the heat dissipation efficiency of the battery pack 41, lowers the operating temperature of the apparatus, and extends the battery life. For the mowing apparatus 1 operating in high-temperature environments, such as during summer mowing operations, it can effectively prevent the apparatus from overheating. When the mowing apparatus 1 is in operation, the second airflow b first cools the battery pack 41, is then guided to the second motor 31 and the impeller 32, and ultimately assists in discharging grass clippings.

Further, the heat-generating component 40 further includes a control module 42 configured to control operation of the mowing apparatus 1, and the control module 42 is disposed on the flow path of the third airflow c. This configuration enables the heat generated by the control module 42 to be effectively carried into the first airflow and the second airflow via the third airflow c and then discharged through the grass-discharge outlet. This can not only effectively cool the control module 42, preventing operational abnormalities or even shutdowns of the control module 42 due to overheating, but also better increase the airflow rate at the grass-discharge outlet. Consequently, this facilitates the further efficient and rapid discharge of grass clippings at the grass-discharge outlet, better preventing the accumulation of grass clippings at the grass-discharge outlet and the resulting obstruction to smooth grass discharge. In some embodiments, the aforementioned control module 42 refers to relevant electronic components used to control the operation of the mowing apparatus. This may include assemblies of electronic components such as PCB boards or power boards, or the assembly housing (heat sink), or may be a single or a few heat-generating electronic components (power semiconductor devices (MOSFET, IGBT), driver ICs, freewheeling diodes, current-sensing resistors, etc.).

In some embodiments, the rotational speed of the second motor is able to be intelligently adjusted based on the weight and quantity of grass clippings to regulate the wind speed of the impeller 32, ensuring smooth discharge of the grass clippings. This enables intelligent adjustment of the airflow rate of the impeller 32, dynamically balancing overall power consumption and performance according to operating conditions, thereby extending the apparatus’s operational duration and improving work efficiency.

In some embodiments, the mowing apparatus 1 further includes a detection component configured to detect the accumulation of grass clippings at the grass-discharge outlet 121. Both the detection component and the second motor 31 are connected to the control module 42, and the control module 42 is configured to control the rotational speed of the second motor 31 based on the accumulation of grass clippings detected by the detection component at the grass-discharge outlet 121.

In some embodiments, the detection component may be an anemometer and is disposed at the grass-discharge outlet 121. More specifically, when the detection component detects that the wind speed at the grass-discharge outlet 121 is greater than or equal to a first preset wind speed value, it indicates smooth flow of grass clippings at the corresponding grass-discharge outlet 121. In this case, there is no need to activate the second motor 31, and grass discharge solely through the action of the first motor 21 suffices to meet normal operational requirements. When the detection component detects that the wind speed at the grass-discharge outlet 121 is less than the first preset wind speed value, it indicates unsmooth flow of grass clippings at the corresponding grass-discharge outlet 121. In this case, it is necessary to activate the second motor 31, requiring the combined action of both the first motor 21 and the second motor 31 to enhance the grass-discharge power at the grass-discharge outlet 121 for effective discharge of grass clippings.

In some embodiments, when the detection component detects that the wind speed at the grass-discharge outlet 121 is less than the first preset wind speed value, the lower the detected wind speed at the grass-discharge outlet 121, the poorer the grass discharge smoothness and the more severe the blockage at the corresponding grass-discharge outlet 121. Accordingly, there is a need to further increase the rotational speed of the corresponding second motor 31 to ensure smooth grass discharge. Therefore, intelligent regulation of the supplemental air volume enables dynamic balancing of overall power consumption and performance according to operating conditions, extending the apparatus’s operational duration and improving work efficiency.

In some embodiments, the control module 42 may also be configured to control the activation and rotational speed of the second motor 31 according to different operating modes of the mowing apparatus 1. More specifically, when dealing with heavy vegetation or wet grass, users select the corresponding operating mode, and the control module 42 then controls the activation of the second motor 31 according to the selected mode and regulates the rotational speed of the second motor 31 according to the grass-discharge conditions.

In some embodiments, the control module 42 may also be configured to control the activation and rotational speed of the second motor 31 according to the magnitude of the load. More specifically, when the cutting load on the a cutting assembly is greater than or equal to a preset load, the control module 42 activates the second motor 31. Under such circumstances, it correspondingly adjusts the starting speed of the second motor 31 according to the magnitude of the load to ensure smooth grass discharge at the grass-discharge outlet 121.

In some embodiments the control module 42 is configured to: adjust the rotational speed of the second motor 31 according to the comparison result between load parameters and a preset threshold. This facilitates precise regulation of the rotational speed of the second motor 31 according to the load parameters, allowing the rotational speed of the second motor 31 to better align with the load state of the cutting assembly 20, thereby guaranteeing the effectiveness of supplemental air and grass discharge. Using the mowing apparatus provided in some embodiments can not only effectively increase the supplemental airflow through the second motor 31 to improve grass-discharge performance but also enable precise control of the rotational speed of the second motor 31 according to load parameters. This ensures that the rotational speed of the second motor 31 better aligns with the load state of the cutting assembly 20, guaranteeing the effectiveness of supplemental air and grass discharge.

In some embodiments, the load parameters include at least one of torque, rotational speed, current, or vibration intensity. This facilitates accurate acquisition of the load state of the cutting assembly through the aforementioned load parameters, thereby further improving the control accuracy of the second motor 31.

In some embodiments, a load parameter detection unit is a current sensor installed on a power input line of the first motor and configured to detect a current value of the first motor in real time and transmit the current value as a load parameter to the control module 42. This configuration facilitates precise regulation of the rotational speed of the second motor 31 according to the current value of the first motor, enabling the rotational speed of the second motor 31 to more accurately align with the load state of the main motor.

In some embodiments, the control module 42 is configured to adjust the rotational speed of the second motor 31 according to a comparison result between the current value detected by the current sensor and a preset threshold, where the preset threshold is set at 70% to 90% of the rated current of the main motor. This ensures that the first motor 21 operates within a relatively safe current range, thereby guaranteeing the normal operation and service life of the first motor 21.

In some embodiments, the mowing apparatus further includes a temperature detection unit disposed at the heat-generating component 40, where the temperature detection unit is configured to detect a temperature value of the heat-generating component and transmit the temperature value as a load parameter to the control module 42. This configuration facilitates precise regulation of the rotational speed of the second motor 31 according to the temperature value of the heat-generating component 40, enabling the rotational speed of the second motor 31 to more accurately align with the load state of the first motor.

In some embodiments, the heat-generating component 40 not only includes the battery pack 41 installed on the housing assembly 10, the heat-generating electronic components of the control module 42, and the first motor 21, but also includes potential heat-generating components 40 mentioned above. This configuration facilitates accurate determination of the load state of the mowing apparatus according to its primary heat-generating components, thereby improving precise regulation of the second motor 31. This ensures that the rotational speed of the second motor 31 better aligns with the load state of the first motor, optimizing grass-discharge efficiency through supplemental air.

In some embodiments, a low grass-discharge speed may also correspond to a situation where the grass collection basket 90 is already full. When the rotational speed of the second motor 31 is increased to its maximum value and the detected flow smoothness of grass clippings remains low, the control module 42 then controls an indicator component of the mowing apparatus 1 to issue an alert signal, so as to alert users to check the filling status of the grass collection basket 90 for timely emptying when the grass collection basket 90 is full. In some embodiments, the alert signal may be an auditory signal, a visual signal, or similar signals.

In some embodiments, the housing assembly 10 includes a mounting housing assembly 14 and a cutting housing assembly 15, where the mounting housing assembly 14 has an air inlet 11, a mounting cavity 141 fluidly connected to the air inlet 11, a first connecting opening 142, and a second connecting opening 143. The first connecting opening 142 and the second connecting opening 143 both are fluidly connected to the mounting cavity 141; the heat-generating component 40 is installed within the mounting cavity 141; the first connecting opening 142 is fluidly connected to an inlet side of the impeller 32; the cutting housing assembly 15 is connected to the mounting housing assembly 14 and encloses the cutting cavity 13 and the grass-discharge channel 12, which are separated from the mounting cavity 141; and the second connecting opening 143 is fluidly connected to the cutting cavity 13. Using the housing assembly 10 provided in some embodiments, the cooperation between the mounting housing assembly 14 and the cutting housing assembly 15 facilitates optimizing the communication methods and flow paths of the first airflow a and the supplemental airflow, consequently facilitating better formation of the first airflow a and the supplemental airflow, thereby effectively ensuring a sufficient airflow for grass discharge at the grass-discharge outlet 121.

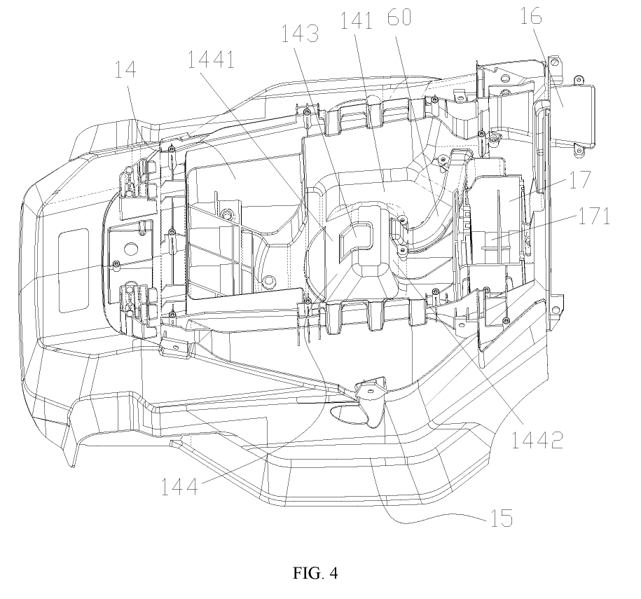

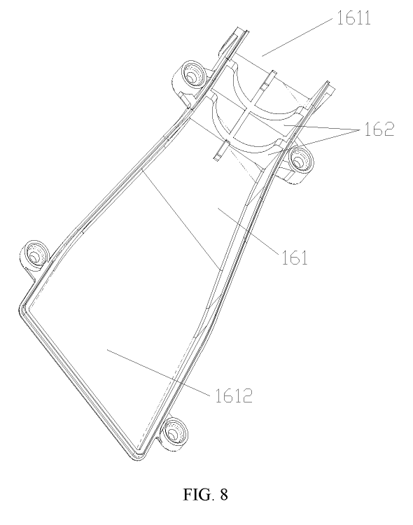

As shown in FIGS. 4 and 8, in some embodiments, the housing assembly 10 further includes a supplemental air housing 16 connected to the mounting housing assembly 14 and the cutting housing assembly 15, where the supplemental air housing 16 is configured to enclose a supplemental air channel 161. In some embodiments, the supplemental air housing 16 encloses the supplemental air channel 161 together with other adjacent housings, such as the cutting housing assembly 15 and/or the mounting housing assembly 14. Certainly, as an alternative embodiment, the supplemental air housing 16 independently encloses the supplemental air channel 161. For example, the supplemental air housing 16 is a tubular component with an enclosed peripheral wall, and it may be either square tubular or circular tubular. The second motor 31 and the impeller 32 are both disposed within the supplemental air channel 161, a supplemental air inlet 1611 of the supplemental air channel 161 is fluidly connected to the first connecting opening 142, a supplemental air outlet 1612 of the supplemental air channel 161 is fluidly connected to the grass-discharge outlet 121, and the supplemental airflow flows through the supplemental air channel 161. This structural configuration, by providing the supplemental air housing 16, helps concentrate the airflow generated by the impeller 32 within the supplemental air channel 161. This ensures that the supplemental airflow generated by the impeller 32 can be concentrated through the supplemental air channel 161 to act upon the grass-discharge outlet 121, preventing significant loss of the supplemental airflow. Consequently, it better ensures that the supplemental airflow can more effectively act upon the grass-discharge outlet 121, thereby further increasing the discharge speed of grass clippings at the grass-discharge outlet 121.

In some embodiments, the first airflow a and the supplemental airflow converge within the supplemental air channel 161. Certainly, as an alternative embodiment, the first airflow a and the supplemental airflow may converge before entering the supplemental air channel 161; or, the first airflow a and the supplemental airflow may also converge in the mounting cavity 141; or, the first airflow a and the supplemental airflow may converge at the grass-discharge outlet 121; or, the first airflow a and the supplemental airflow converge upstream of the grass-discharge outlet 121. The convergence point is not limited herein, provided that both of the airflows flow out through the grass-discharge outlet 121.

In some embodiments, the second airflow b and the third airflow c converge within the supplemental air channel 161; and paths of the second airflow b and the third airflow c are at least partially different upstream of a convergence point. Certainly, as an alternative embodiment, the second airflow b and the third airflow c may also converge within the mounting cavity 141, or converge respectively within the mounting cavity 141 and the supplemental air channel 161. The convergence point is not limited herein, provided that both of the airflows flow out through the grass-discharge outlet 121.

Through the added supplemental air housing 16, an additional channel is provided for the second airflow b and the third airflow c to flow through, assisting the grass-discharge channel 12. This ensures that, even under high-load or wet grass conditions, the second airflow b and the third airflow c, under the concentrated guidance of the supplemental air housing 16, can facilitate the smooth discharge of grass clippings, thereby significantly increasing the airflow rate and velocity at the grass-discharge outlet 121 and improving the discharge efficiency of grass clippings.

In some embodiments, the supplemental air housing 16 is installed on a portion of the cutting housing assembly 15 that encloses the grass-discharge channel 12 and extends along an extension direction of the grass-discharge channel 12, the cutting housing assembly 15 is provided with a third connecting opening 151 penetrating through inner and outer wall surfaces of the grass-discharge channel 12, the supplemental air outlet 1612 is fluidly connected to the third connecting opening 151, and the third connecting opening 151 is disposed facing toward the grass-discharge outlet 121. This structural configuration facilitates optimizing the configuration of the supplemental air housing 16 so that the extension direction of the supplemental air channel 161 aligns with the extension direction of the grass-discharge channel 12. This ensures that the flow velocity of the supplemental airflow exiting through the third connecting opening 151 remains as consistent as possible with the flow velocity of the airflow within the grass-discharge channel 12, preventing airflow turbulence caused by a significant directional deviation between the flow velocity of the supplemental airflow exiting through the third connecting opening 151 and the flow velocity of the airflow within the grass-discharge channel 12, or reduced airflow velocity caused by a collision between the two airflows. Therefore, the layout of the supplemental air channel 161 is better optimized, further improving the flow direction of the supplemental airflow and effectively increasing the discharge speed of grass clippings at the grass-discharge outlet 121.

Furthermore, the configuration of the third connecting opening 151 facing the grass-discharge outlet 121 ensures that the supplemental airflow, after passing through the supplemental air channel 161, directly acts upon the grass-discharge outlet 121. This maximizes the improvement of grass-discharge efficiency, enhances the specificity and effectiveness of supplemental air, ensures smoother discharge of grass clippings, and increases the grass-discharge speed.

In some embodiments, along an extension direction from the supplemental air inlet 1611 to the supplemental air outlet 1612, a flow cross-sectional area of the supplemental air channel 161 gradually increases. This structural configuration enables the supplemental airflow flowing through the supplemental air channel 161 to more smoothly exit toward the grass-discharge outlet 121 via the third connecting opening 151, thereby enhancing the flow smoothness of the supplemental airflow. By optimizing the geometric shape of the supplemental air channel 161, the airflow resistance is reduced, and the airflow velocity is increased.

In some embodiments, a fan can be arranged at the supplemental air inlet 1611 to ensure that the initial thrust of the airflow is sufficiently strong. This can improve the supplemental air efficiency of the second motor 31, making the supplemental airflow smoother and the discharge of grass clippings more efficient, effectively preventing the accumulation of grass clippings.

In some embodiments, the wall surfaces of the supplemental air housing 16 and the cutting housing assembly 15 are spliced to enclose the supplemental air channel 161. This structural configuration facilitates optimizing the connection relationships and layout between the housing structures, fully utilizing the interrelations between the housings, reducing unnecessary housings, and minimizing the overall machine weight by reducing unnecessary housing structures.

In some embodiments, the supplemental air housing 16 and the cutting housing assembly 15 may be separate and independent housings. They can be manufactured individually and then assembled by splicing. This also facilitates the installation of the second motor 31 and the impeller 32, as well as their maintenance and repair.

To ensure the connection stability between the supplemental air housing 16 and the cutting housing assembly, the supplemental air housing 16 and the cutting housing assembly can be fixedly connected via a positioning structure. This configuration can also ensure the supplemental air stability of the supplemental air channel 161.

Correspondingly, the positioning structure can be flexibly configured and is at least one selected from the following manners: a) a mechanical connection structure, including fixedly connecting the supplemental air housing 16 and the cutting housing assembly using at least one of threaded fasteners, snap-fit fasteners, or riveted fasteners; b) an adhesive structure, including an adhesive layer or a welding joint interface disposed on the supplemental air housing 16 and the cutting housing assembly; c) an interference fit structure, generating a clamping force through deformation of contact surfaces between the supplemental air housing 16 and the cutting housing assembly; d) a magnetic connection structure, including magnetic elements disposed on the supplemental air housing 16 and the cutting housing assembly; and e) a sliding fit structure, including mutually matched guide grooves and guide rails disposed on the supplemental air housing 16 and the cutting housing assembly. Using the positioning structure of at least one of the aforementioned manners for positioning and connection facilitates ensuring the connection stability between the supplemental air housing 16 and the cutting housing assembly, thereby guaranteeing the supplemental air stability of the supplemental air channel 161.

The positioning structure may be correspondingly configured as a combined structure and may include a combined structure of a mechanical connection structure and an adhesive structure, or a combined structure of a mechanical connection structure and a magnetic connection structure, or a combined structure of a mechanical connection structure and a sliding fit structure. In some embodiments, the positioning structure may first engage via a sliding fit structure, and after sliding into position, it can be fixedly connected using a mechanical connection structure, an adhesive structure, an interference fit structure, or a magnetic connection structure to ensure connection stability.

To facilitate the disassembly or assembly of the supplemental air housing 16, the positioning structure is a detachable connection structure. This configuration facilitates the maintenance, inspection, and replacement of the supplemental air housing 16 as well as the second motor 31 and the impeller 32 contained therein.

Alternatively, the supplemental air housing 16 and the cutting housing assembly 15 form an integrally formed structure, which facilitates production and manufacturing and enhances the connection stability and structural strength between the supplemental air housing 16 and the cutting housing assembly.

In some embodiments, the cutting housing assembly includes a volute section and an air outlet housing section that are connected to each other, where the volute section is provided with an air inlet 11, and the grass-discharge channel 12 is disposed on a side of the air outlet housing section away from the volute section; the supplemental air housing 16 is installed on the air outlet housing section, and the supplemental air channel 161 extends along an extension direction of the air outlet housing section; and/or, the supplemental air outlet 1612 is located on a side of the supplemental air inlet 1611 closer to the grass-discharge channel 12. The combination of the volute section and the air outlet housing section can not only improve the manufacturing flexibility and assembly convenience of the apparatus but also ensure that, through the installation position of the supplemental air housing 16, the supplemental airflow can act more directly on the grass clipping discharge process. During actual cutting operations, this design can significantly enhance the grass-discharge performance of the mowing apparatus under wet grass or high-load conditions, preventing clogging at the grass-discharge outlet and improving the user experience and work efficiency of the mowing apparatus. At the same time, the combined design of the volute section and the air outlet housing section can also improve the ease of maintenance of the apparatus and the replaceability of components, extending the service life of the apparatus.

The mowing apparatus 1 further includes a positioning assembly installed on an air duct wall of the supplemental air channel 161, where the positioning assembly has a positioning space adapted to at least a portion of the second motor 31, and both the second motor 31 and the impeller 32 are installed within the positioning space. The design of the positioning assembly can not only improve the installation accuracy and stability of the second motor 31 and the impeller 32 but also ensure, through the adaptation of the positioning space, that the airflow from the second motor 31 and the impeller 32 can act more directly on the supplemental air channel 161, thereby enhancing supplemental air efficiency. In practical applications, the use of the positioning assembly can significantly enhance the grass-discharge performance of the mowing apparatus under wet grass or high-load conditions, preventing clogging at the grass-discharge outlet 121 and improving the user experience and work efficiency of the mowing apparatus. At the same time, the design of the positioning assembly can also improve the ease of maintenance of the apparatus and the replaceability of components, extending the service life of the apparatus.

In some embodiments, the wall surfaces of the supplemental air housing 16 and the cutting housing assembly are spliced to enclose the supplemental air inlet 1611, the supplemental air outlet 1612, and the supplemental air channel 161. The positioning assembly includes a first positioning member 162 and a second positioning member, where the first positioning member 162 is disposed on the supplemental air housing 16 and has a first positioning notch; the second positioning member is disposed on the cutting housing assembly and has a second positioning notch; and the second positioning notch and the first positioning notch together enclose the positioning space. By splicing the wall surfaces of the supplemental air housing 16 and the cutting housing, not only can the manufacturing accuracy and assembly stability of the apparatus be improved, but the airtightness of the supplemental air channel 161 and the smooth flow of air can also be ensured. The combined design of the first positioning member 162 and the second positioning member can not only improve the installation accuracy and stability of the second motor 31 but also ensure, through the adaptation of the positioning space, that the airflow from the impeller 32 can act more directly on the supplemental air channel 161, thereby enhancing supplemental air efficiency. In practical applications, this design can significantly enhance the grass-discharge performance of the mowing apparatus under wet grass or high-load conditions, preventing clogging at the grass-discharge outlet and improving the user experience and work efficiency of the mowing apparatus. At the same time, the splicing of the wall surfaces of the supplemental air housing 16 and the cutting housing assembly, along with the design of the positioning assembly, can also improve the ease of maintenance of the apparatus and the replaceability of components, extending the service life of the apparatus.

In some embodiments, the second motor 31 and the impeller 32 are coaxially arranged, and the projected area of the second motor 31 in the radial direction of the impeller 32 is relatively small, so that the airflow velocity of the impeller 32 will not be affected.

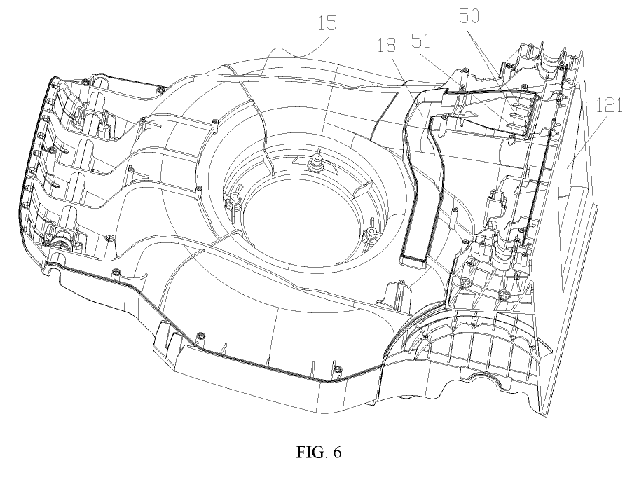

As shown in FIG. 6, in some embodiments, the mowing apparatus 1 further includes a flow guiding member 50 disposed within the supplemental air housing 16, where the flow guiding member 50 has a flow guiding surface 51 extending along an extension direction of the supplemental air channel 161, and the flow guiding surface 51 is configured to guide an airflow entering from the supplemental air inlet 1611 to the supplemental air outlet 1612. This structural configuration facilitates effective guidance of the supplemental airflow flowing through the supplemental air channel 161 via the flow guiding member 50, smoothly guiding the supplemental airflow to the supplemental air outlet 1612 and then discharging it toward the grass-discharge outlet 121 via the third connecting opening 151. During actual cutting operations of the cutting assembly 20, the use of the flow guiding member 50 can significantly enhance the grass-discharge performance of the mowing apparatus under wet grass or high-load conditions, preventing clogging of the grass-discharge channel 12 and improving the user experience and work efficiency of the mowing apparatus. At the same time, the configuration of the flow guiding member 50 can also improve the ease of maintenance of the apparatus and the replaceability of components, extending the service life of the apparatus.

In some embodiments, the flow guiding surface 51 may be a curved flow guiding surface or an inclined flow guiding surface, provided that the flow guiding surface 51 can effectively direct and guide the supplemental airflow.

In some embodiments, the flow guiding member 50 is provided in plurality, and the plurality of flow guiding members 50 are spaced apart. This structural configuration facilitates better guidance of the supplemental airflow flowing through the supplemental air channel 161, thereby better optimizing the flow direction of the supplemental airflow so that the supplemental airflow flows more effectively toward the supplemental air outlet 1612.

In some embodiments, some of the flow guiding members 50 may be spaced apart along a direction from the supplemental air inlet 1611 to the supplemental air outlet 1612, or some may be spaced apart along a direction perpendicular to or inclined relative to the direction from the supplemental air inlet 1611 to the supplemental air outlet 1612.

In some embodiments, a first end of the flow guiding member 50 is disposed within the supplemental air channel 161 and has the flow guiding surface 51. This facilitates smooth guidance of the supplemental airflow from the first end of the flow guiding member 50, thereby better guiding the supplemental airflow toward the supplemental air outlet 1612.

In some embodiments, the flow guiding surface 51 at the first end of the flow guiding member 50 may be a curved flow guiding surface; moreover, along an extension direction from a flow guiding inlet to a flow guiding outlet, the distance between the curved flow guiding surface and the bottom of the supplemental air channel 161 gradually increases.

In some embodiments, a second end of the flow guiding member 50 is disposed at the supplemental air outlet 1612 and is provided with the flow guiding surface 51. This structural configuration facilitates smooth guidance of the supplemental airflow from the second end of the flow guiding member 50, thereby better guiding the supplemental airflow toward the supplemental air outlet 1612.

In some embodiments, the flow guiding surface 51 at the second end of the flow guiding member 50 may be an inclined flow guiding surface; moreover, along the extension direction from the flow guiding inlet to the flow guiding outlet, the distance between the curved flow guiding surface and the bottom of the supplemental air channel 161 gradually decreases.

In some embodiments, the extension direction from the first end to the second end of the flow guiding member 50 is the same as the extension direction of the supplemental air channel 161.

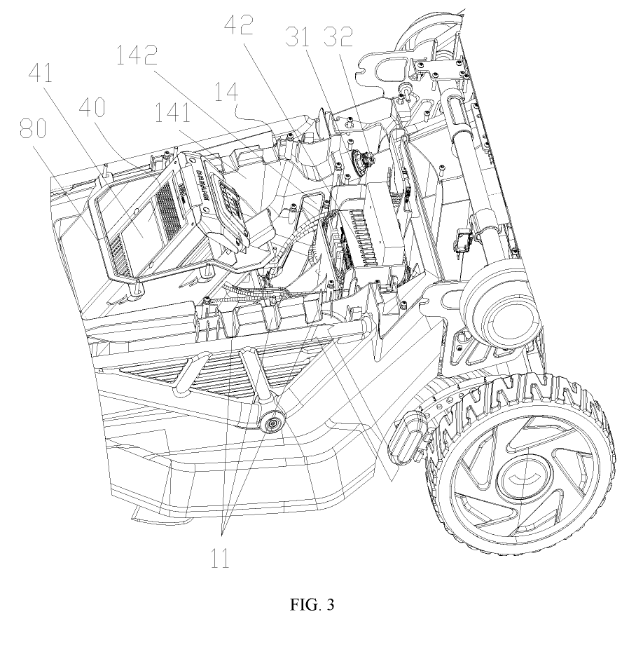

As shown in FIGS. 3 to 5, in some embodiments, the mounting housing assembly 14 includes a connecting portion 144 disposed within the mounting cavity 141 and protruding beyond the bottom of the mounting cavity 141, and a connecting cavity formed inside the connecting portion 144 is fluidly connected to the cutting cavity 13 and the inlet side of the impeller. In some embodiments, the connection cavity is enclosed by the connecting portion 144, connected to the cutting cavity 13, and located above the cutting cavity 13, and the connecting portion 144 includes a support plate 1441 and a connection plate 1442 that are disposed within the mounting cavity 141, opposite to each other, and spaced apart. The heat-generating component 40 includes a battery pack 41 supported on the connecting portion 144, specifically on the support plate 1441. The battery pack 41 includes a heat dissipation inlet 411 and a heat dissipation outlet 412 fluidly connected to the inside of the battery pack, and the heat dissipation outlet 142 is fluidly connected to the connection cavity. In some embodiments, the support plate 1441 is provided with a second connecting opening 143 opposite to the heat dissipation outlet 412 of the battery pack 41 and penetrating through the support plate 1441 to fluidly connected to the connection cavity, the connection plate 1442 is provided with a fourth connecting opening 14421 penetrating through the connection plate 1442 and fluidly connected to the connection cavity, and the fourth connecting opening 14421 is fluidly connected to the inlet side of the impeller 32. This structural configuration facilitates improving the configuration of the battery pack 41, the flow path of the first airflow a, and the flow path of the second airflow b, thereby better dissipating the heat from the battery pack 41 through the first airflow a and the second airflow b, optimizing the airflow circulation method, and more effectively increasing the airflow rate at the grass-discharge outlet 121.

In some embodiments, through the structural optimization of the connecting portion 144, the airflow paths are rationally distributed to ensure effective heat dissipation from the battery pack 41 via the airflow while also guiding the airflow to the supplemental air channel 161, thereby enhancing grass-discharge capacity and improving the overall performance of the apparatus in both heat dissipation and grass discharge. Under operating conditions where both heat dissipation and grass-discharge efficiency need to be considered, such as when operating in dense vegetation areas, it effectively improves the overall operational performance.

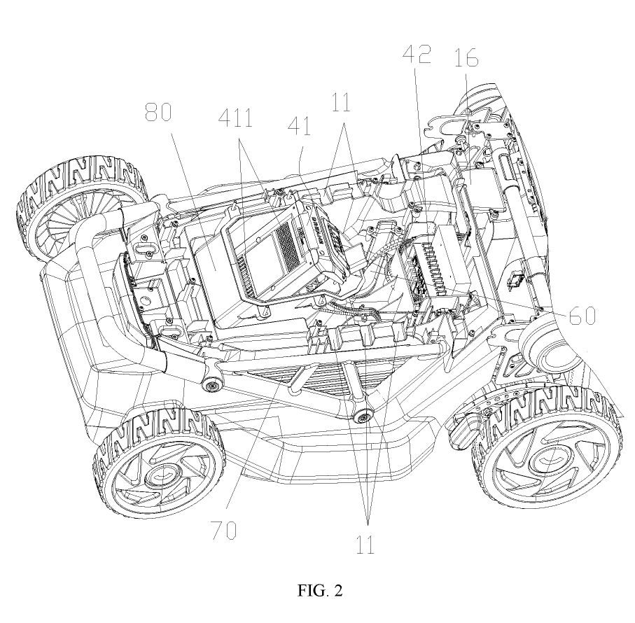

As shown in FIGS. 2, 4, and 9, specifically, the mowing apparatus 1 further includes an air guiding housing 60 installed within the mounting cavity 141. In some embodiments, the air guiding housing 60 independently encloses an air guiding channel 61 fluidly connected to the connection cavity and the inlet side of the impeller 32. In some embodiments, the air guiding housing 60 is a tubular component and may be rectangular tubular or circular tubular. Certainly, as an alternative embodiment, the air guiding housing 60 may also enclose the air guiding channel 61 together with the mounting housing assembly. The air guiding housing 60 encloses an air guiding inlet 63, an air guiding outlet 62, and an air guiding channel 61 fluidly connected to both the air guiding inlet 63 and the air guiding outlet 62, the air guiding outlet 62 is connected to the first connecting opening 142, and the heat dissipation outlet 412 is connected to the air guiding inlet 63. This configuration facilitates the concentrated and precisely directed guidance of a portion of the heat from the heat dissipation outlet 412 to the air guiding inlet 63 via the air guiding housing 60, optimizing the flow path of the second airflow b. This effectively increases the airflow velocity of the second airflow b, enabling more concentrated and rapid guidance of the heat generated by the battery pack 41, thereby improving the air guiding effect.

In some embodiments, the air guiding housing 60 is installed on the inner wall of the mounting cavity 141, thereby facilitating the optimization of the installation method and layout of the air guiding housing 60. The principle of this installation method is to utilize the inner wall of the mounting cavity 141 as a support for the air guiding housing 60, simplifying the internal structure of the apparatus, saving space, and improving the spatial utilization efficiency of the apparatus. This results in a more compact and lightweight apparatus, suitable for applications requiring a lightweight and miniaturized apparatus, such as mowing operations in confined spaces. Thus, when the mowing apparatus 1 is in operation, the airflow passes through the air guiding channel 61 formed between the air guiding housing 60 and the inner wall of the mounting cavity 141, enabling effective heat exchange and airflow guidance.

The air guiding housing 60 has a notch, and an open end of the notch overlaps with the inner wall of the mounting cavity 141, so that the air guiding housing 60 and the inner wall of the mounting cavity 141 enclose the air guiding channel 61. In this way, a stable airflow guiding structure is formed through the overlapping of the notch and the inner wall, ensuring that the airflow follows a predetermined path. The above structural configuration can enhance the guiding capability and stability for the second airflow b, enabling the apparatus to maintain effective thermal management and grass-discharge performance during operation. In some embodiments, when the mowing apparatus 1 is in operation, the second airflow b passes through the air guiding channel 61 formed by the notch and the inner wall, conducting efficient heat exchange and airflow guidance to ensure the normal operation of the apparatus.

In some embodiments, the air guiding housing 60 is connected to the inner wall of the mounting cavity 141 via a connection structure. More specifically, the connection structure is achieved through threaded connection, adhesive bonding, or snap fitting.

As shown in FIGS. 3 and 4, specifically, the heat-generating component 40 further includes a control module 42. The housing assembly 10 further includes a positioning housing 17, the control module 42 is disposed within the positioning housing 17, and the positioning housing 17 is fluidly connected to the mounting cavity 141 and the inlet side of the impeller 32. In some embodiments, the positioning housing 17 includes a positioning groove 171, where the control module 42 is disposed within the positioning groove 171, and the positioning groove 171 is connected to the inlet side of the impeller 32, so that an airflow flowing from the air inlet 11 into the positioning groove 171 flows to the inlet side of the impeller 32. This configuration facilitates the installation and positioning of the control module 42 and better guides the heat generated by the control module 42 within the positioning groove 171 to the impeller 32 under the action of the third airflow c, optimizing the airflow flow method.

As shown in FIG. 6, specifically, the housing assembly 10 is further provided with an air guiding groove 18 fluidly connected to the positioning housing 17 and the inset side of the impeller 32, the air guiding groove 18 is disposed at the bottom of the positioning groove 171 and located outside the mounting cavity 141, one end of the air guiding groove 18 is fluidly connected t the positioning groove 171, and the other end of the air guiding groove 18 is in fluid communication with the inlet side of the impeller 32. This configuration enables the heat from the control module 42 to be collected and guided through the air guiding groove 18 to the impeller 32, facilitating better flow to the grass-discharge outlet 121 under the action of the third airflow c, thereby increasing the grass-discharge flow velocity. In some embodiments, the air guiding groove 18 includes two portions formed on opposite surfaces of the cutting housing assembly 15 and the mounting housing assembly 14, respectively, which are a first stiffening plate protruding from the cutting housing assembly 15 and a second stiffening plate protruding beyond the surface of the mounting housing assembly 14, and the two stiffening plates are partially correspondingly arranged and enclose the air guiding groove 18 together. Certainly, as an alternative embodiment, the air guiding groove 18 may also be an independent component formed on a side of the cutting housing assembly 15 away from the cutting cavity 13. The air guiding groove 18 forms an enclosed channel with the bottom of the mounting housing assembly 14 and communicates with the mounting cavity and/or the supplemental air channel.

In some embodiments, the cutting housing assembly 15 is further provided with a first air guiding plate and a second air guiding plate, where the first air guiding plate and the second air guiding plate are oppositely arranged and spaced apart to enclose the air guiding groove 18. When the cutting housing assembly 15 is connected to the mounting housing assembly 14, the air guiding groove 18 cooperates with the bottom wall surface of the mounting housing assembly 14 to enclose an air guiding channel allowing the third airflow c to pass through. Certainly, the bottom wall of the mounting housing assembly 14 may also be provided with slots corresponding to the first air guiding plate and the second air guiding plate, and the air guiding groove 18 should be allowed to closely cooperate with the bottom wall of the mounting housing assembly 14 to form a relatively air-tight air guiding channel.

As shown in FIGS. 4 and 6, in some embodiments, a portion of the mounting housing assembly 14 is recessed to enclose the mounting cavity 141, the air inlet 11 is disposed above the mounting cavity 141 and located at a periphery of the mounting cavity 141, and the first connecting opening 142 and the second connecting opening 143 are both disposed on a wall surface of the mounting cavity 141; the air guiding groove 18 is disposed on a side of the cutting housing assembly 15 away from the cutting cavity 13, and the air guiding groove 18 is in fluid communication with the grass-discharge outlet. This layout facilitates optimizing the connection method of the mounting housing assembly 14, the flow path of the second airflow b, and the flow path of the third airflow c. Consequently, it enables the second airflow b and the third airflow c to flow more concentratedly toward the grass-discharge outlet 121, thereby better increasing the discharge speed of grass clippings at the grass-discharge outlet 121.

As shown in FIGS. 3 to 6, the mounting housing assembly 14 includes a support housing and a cover body, where the support housing includes a first housing plate and a second housing plate that are connected to each other, the first housing plate is recessed, the second housing plate is arranged around a periphery of the first housing plate, and the second housing plate is provided with an air inlet 11; the cover body is placed on and covers the second housing plate so that the support housing and the first housing plate enclose the mounting cavity 141. The first housing plate is provided with a first connecting opening 142, a side of the cutting housing assembly away from the cutting space is provided with an air guiding groove 18, the positioning groove 171 is in fluid communication with the inlet end of the air guiding groove 18, and the outlet end of the air guiding groove 18 is in fluid communication with the first connecting opening 142 and/or the supplemental air inlet 1611. In this way, a sealed mounting cavity 141 is formed by the support housing and the cover body, providing a favorable heat dissipation environment for the heat-generating component 40 while facilitating effective protection for the heat-generating component 40. Simultaneously, the path of the third airflow c is optimized through the air guiding groove 18, enhancing both heat dissipation efficiency and grass-discharge efficiency. The above structural configuration can improve the apparatus’s heat dissipation capability and grass-discharge efficiency, enabling the apparatus to maintain high-performance operation under various operating conditions. It is particularly suitable for scenarios requiring efficient heat dissipation and grass discharge from the apparatus, such as mowing operations in high-humidity environments. In some embodiments, when the mowing apparatus 1 is in operation, air enters from the air inlet 11 through the mounting cavity 141 formed by the support housing and the cover body, providing cooling to the control module via the third airflow c, and then the air flows to the impeller 32 via the air guiding groove 18 and proceeds to the grass-discharge outlet 121 to participate in the grass clipping discharge process.

As shown in FIGS. 2 and 3, there are at least two air inlets 11, which are spaced apart along the periphery of the mounting cavity 141. In this way, air intake through the at least two air inlets 11 increases the intake airflow rate, improves the coverage and efficiency of the airflow, and reduces the burden on a single air inlet 11.

In some embodiments, the at least two air inlets 11 are spaced apart along a periphery of the first housing plate. This optimizes the structural layout and configuration of the air inlets 11, improving the balance of airflow and the heat dissipation efficiency of the apparatus, thereby allowing the apparatus to maintain a lower temperature during operation. When the mowing apparatus 1 is in operation, air flows into the mounting cavity 141 uniformly through the multiple air inlets 11, providing cooling for the heat-generating component 40, and then the air flows to the supplemental air system to participate in the grass clipping discharge process.

In some embodiments, the first housing plate is provided with openings, which are located above the mounting cavity 141 and form the structure of the air inlet 11. Correspondingly, the first housing plate is provided with at least two openings, each used to form an air inlet 11.

As shown in FIG. 2, to prevent external debris from entering the mounting cavity 141 through the air inlet 11, the mowing apparatus 1 in some embodiments further includes an air intake grille 70 disposed at the air inlet 11, allowing external air to enter the air inlet 11 through the air intake grille 70. In some embodiments, the at least two air inlets 11 are distributed on two sides of the mounting cavity 141. Correspondingly, two air intake grilles 70 may be arranged, each disposed on one side of the mounting cavity 141 to cover the respective air inlet 11, enabling air intake through the corresponding air intake grille 70.

In some embodiments, the air intake grille 70 is detachably installed on the housing assembly 10 to facilitate cleaning and maintenance of the air intake grille 70.

In some embodiments, the cutting housing assembly includes a main housing and a lap joint housing that are connected to each other, where the lap joint housing is installed on the wall surface of the main housing and is spliced with the supplemental air housing 16 to enclose the supplemental air channel 161. Designing the cutting housing assemblyas a combination of the main housing and the lap joint housing can not only enhance the manufacturing flexibility and assembly convenience of the apparatus but also form the supplemental air channel 161 through the splicing of the lap joint housing and the supplemental air housing 16, ensuring smooth flow of the supplemental airflow. In practical applications, this configuration can significantly enhance the grass-discharge performance of the mowing apparatus under wet grass or high-load conditions, preventing clogging at the grass-discharge outlet and improving the user experience and work efficiency of the mowing apparatus. At the same time, the combined design of the main housing and the lap joint housing can also improve the ease of maintenance of the apparatus and the replaceability of components, extending the service life of the apparatus.

In some embodiments, the main housing includes a volute section and an air outlet housing section that are connected to each other, where a portion of the volute section and the air outlet housing section enclose the grass-discharge channel 12, while another portion of the volute section encloses the cutting space.

In some embodiments, the lap joint housing includes a first housing plate, a second housing plate, and a positioning housing plate, where the first housing plate and the second housing plate are spaced apart and oppositely arranged, the positioning housing plate is disposed at the ends of the first housing plate and the second housing plate, one side of the supplemental air housing 16 is lapped onto the first housing plate, and the other side of the supplemental air housing 16 is lapped onto the second housing plate, with an end of the supplemental air housing 16 abutting against the positioning housing plate. This configuration of the lap joint housing, through the combination of the first housing plate, the second housing plate, and the positioning housing plate, can not only improve the manufacturing accuracy and assembly stability of the apparatus but also ensure accurate installation and positioning of the supplemental air housing 16, preventing deviations and airflow leakage during installation. In practical applications, this configuration can significantly enhance the grass-discharge performance of the mowing apparatus under wet grass or high-load conditions, preventing clogging at the grass-discharge outlet and improving the user experience and work efficiency of the mowing apparatus. At the same time, the design of the lap joint housing can also improve the ease of maintenance of the apparatus and the replaceability of components, extending the service life of the apparatus.

In some embodiments, the supplemental air housing 16 includes a lap joint cover and a fitting portion that are connected to each other, where the lap joint cover is lapped onto the first housing plate and the second housing plate, with an end of the lap joint cover abutting against the positioning housing plate; both the first housing plate and the second housing plate are spaced apart from the positioning housing plate to form a positioning gap, and at least a portion of the lap joint cover is installed at the positioning gap; the fitting portion is located at the ends of the first housing plate and the second housing plate and is configured to fit against the main housing. The coordinated configuration of the lap joint cover and the fitting portion of the supplemental air housing 16 can not only improve the manufacturing accuracy and assembly stability of the apparatus but also ensure a tight fit between the supplemental air housing 16 and the cutting housing assembly, preventing airflow leakage and installation deviations. In practical applications, this design can significantly enhance the grass-discharge performance of the mowing apparatus under wet grass or high-load conditions, preventing clogging at the grass-discharge outlet and improving the user experience and work efficiency of the mowing apparatus. At the same time, the configuration of the lap joint cover and the fitting portion can also improve the ease of maintenance of the apparatus and the replaceability of components, extending the service life of the apparatus.

In some embodiments, the fitting portion includes a first fitting plate and a second fitting plate, where the first fitting plate and the second fitting plate are respectively disposed on two sides of the lap joint cover and extend from the two sides of the lap joint cover. By arranging the first fitting plate and the second fitting plate on two sides of the lap joint cover, not only can the fitting tightness between the supplemental air housing 16 and the cutting housing assembly be improved, but also more stable support and positioning are provided through the fitting plates on the two sides, preventing vibration and airflow leakage during the operation of the apparatus. In practical applications, this configuration can significantly enhance the grass-discharge performance of the mowing apparatus under wet grass or high-load conditions, preventing clogging at the grass-discharge outlet and improving the user experience and work efficiency of the mowing apparatus. At the same time, the design of the first fitting plate and the second fitting plate can also improve the ease of maintenance of the apparatus and the replaceability of components, extending the service life of the apparatus.

In some embodiments, the mowing apparatus 1 further includes a battery compartment 80 installed within the mounting cavity 141, where the battery compartment 80 has an accommodation cavity and an accommodation opening fluidly connected to the accommodation cavity, the battery pack 41 is detachably arranged within the accommodation cavity via the accommodation opening, and the accommodation opening is in fluid communication with the mounting cavity 141. The battery compartment 80 is provided with an air outlet, which is in fluid communication with the heat dissipation outlet 412, so that the airflow entering the mounting cavity 141 through the accommodation opening sequentially passes through a heat dissipation inlet 411, the accommodation cavity, and a heat dissipation outlet 412, and then flows out through the air outlet. In this way, the structural design of the battery compartment 80 provides a detachable installation method for the battery pack 41, facilitating battery replacement and maintenance while utilizing airflow for heat dissipation of the battery pack 41. The above configuration improves the ease of maintenance of the battery pack 41 and the heat dissipation efficiency of the apparatus, extends the service life of the battery, and makes it suitable for scenarios requiring frequent battery replacement or apparatus operation in high-load environments.

This disclosure at least provides the following beneficial effects: optimizing the airflow path and improving the apparatus’ heat dissipation efficiency and grass-discharge performance. The air inlet 11, the mounting cavity 141, the supplemental air channel 161, the grass-discharge channel 12, the battery compartment 80, and the positioning groove 171 for the control module 42 collectively form a complete airflow network. The introduction of the second motor 31 and the impeller 32 not only enhances the performance of the entire heat dissipation system but also significantly increases the airflow rate and velocity at the grass-discharge outlet 121, thereby improving the grass collection efficiency and capacity of the grass collection basket and reducing the frequency of cleaning grass clippings by users. The mechanism for intelligently regulating the supplemental air volume enables dynamic adjustment according to different operating conditions, balancing the apparatus’s power consumption and performance, extending operational duration, and improving work efficiency. Simultaneously, the configuration of the air guiding groove 18 and the air guiding housing 60 further optimizes the airflow path, ensuring the heat dissipation requirements of the battery pack 41 and the control module 42, and enhancing the stability and safety of the apparatus. In practical applications, this series of designs can significantly improve the situation of grass clipping flow, particularly under high-load or wet grass conditions, thereby improving user experience and apparatus performance.

For those skilled in the art, it is evident that this disclosure is not limited to the details of the above exemplary embodiments, and can be implemented in other specific forms without departing from the spirit or essential characteristics of this disclosure. Therefore, from any perspective, the embodiments should be regarded as illustrative and non-limiting. The scope of this disclosure is defined by the appended claims rather than the above description, and all changes falling within the meaning and range of equivalents of the claims are intended to be included in this disclosure. No reference sign in the claims should be construed as limiting the scope of the respective claim.

Furthermore, it should be understood that although this specification is described in terms of embodiments, each embodiment does not necessarily contain only a single independent technical solution. This narrative style in the specification is merely for clarity, and those skilled in the art should treat the specification as a whole. The technical solutions in the various embodiments may also be appropriately combined to form other embodiments that can be understood by those skilled in the art.

What is claimed is:

1. A mowing apparatus, comprising:
a housing assembly, comprising an air inlet open to outside, a grass-discharge channel, and a cutting cavity fluidly connected to the air inlet and the grass-discharge channel, wherein an end of the grass-discharge channel away from the cutting cavity forms a grass-discharge outlet open to outside;
a cutting assembly disposed within the cutting cavity, the cutting assembly comprising a first motor, and a cutting blade coupled to the first motor, wherein rotation of the cutting blade generates a first airflow, the first airflow flows into the grass-discharge channel through the cutting cavity, and exits through the grass-discharge outlet; and
a second motor and an impeller disposed adjacent to the grass-discharge outlet, wherein the second motor is operatively coupled to the impeller, rotation of the impeller generates a supplemental airflow, and the supplemental airflow flows past the impeller and exits through the grass-discharge outlet.

2. The mowing apparatus of claim 1, further comprising:
a heat-generating component disposed within the housing assembly, wherein at least a portion of the supplemental airflow flows past the heat-generating component and exits through the grass-discharge outlet .

3. The mowing apparatus of claim 2, wherein
the heat-generating component comprises a battery pack providing a power source for the mowing apparatus, the mowing apparatus further comprises a control module configured to control operation of the mowing apparatus, and the heat-generating component is disposed along at least one flow path of the first airflow or the supplemental airflow; or
the mowing apparatus further comprises a control module configured to control operation of the mowing apparatus, and the heat-generating component is disposed along at least one flow path of the first airflow or the supplemental airflow; or
the heat-generating component comprises a battery pack providing a power source for the mowing apparatus, and the heat-generating component is disposed along at least one flow path of the first airflow or the supplemental airflow.

4. The mowing apparatus of claim 3, wherein the battery pack is disposed along a flow path of each of the first airflow and the supplemental airflow; and the control module is disposed along a path of the supplemental airflow.

5. The mowing apparatus of claim 2, wherein the housing assembly comprises
a mounting housing assembly, comprising the air inlet and a mounting cavity in fluid fluidly connected to the air inlet, wherein the heat-generating component is disposed within the mounting cavity, and the mounting cavity is in fluid communication with an inlet side of the impeller; and
a cutting housing assembly connected to the mounting housing assembly comprising the cutting cavity and the grass-discharge channel, wherein the mounting cavity is in fluid communication with the cutting cavity.

6. The mowing apparatus of claim 4, wherein the housing assembly further comprises a supplemental air housing connected to the mounting housing assembly and the cutting housing assembly, wherein:
the supplemental air housing defining a supplemental air channel,
the second motor and the impeller are both disposed within the supplemental air channel,
the supplemental air channel is in fluid communication with both the mounting cavity and the grass-discharge outlet, and
the supplemental airflow flows through the supplemental air channel.

7. The mowing apparatus of claim 6, wherein the first airflow and the supplemental airflow converge at the mounting cavity; or,
the first airflow and the supplemental airflow converge before entering into the supplemental air channel; or,
the first airflow and the supplemental airflow converge within the supplemental air channel; or,
the first airflow and the supplemental airflow converge at the grass-discharge outlet; or,
the first airflow and the supplemental airflow converge upstream of the grass-discharge outlet.

8. The mowing apparatus of claim 7, wherein the supplemental airflow comprises a second airflow and a third airflow merging within at least one of the mounting cavity or the supplemental air channel; and the second airflow path and the third airflow path differs upstream of a merging location.

9. The mowing apparatus of claim 8, wherein the second airflow flows past the battery pack, and the third airflow flows past the control module.

10. The mowing apparatus of claim 6, wherein the supplemental air housing is mounted to the cutting housing assembly, the cutting housing assembly is provided with a third connecting opening extending between an interior and an exterior of the grass-discharge channel, and the third connecting opening is in fluid communication with both the supplemental air channel and the grass-discharge outlet.

11. The mowing apparatus of claim 6, wherein
along a direction from an inlet to a outlet of the supplemental air channel, a flow cross-sectional area of the supplemental air channel gradually increases.

12. The mowing apparatus of claim 6, further comprising:
a flow guiding member disposed within the supplemental air housing, wherein the flow guiding member comprises a flow guiding surface extending along an flow direction of the supplemental air channel, and the flow guiding surface is configured to direct an airflow entering from a inlet toward a outlet of the supplemental air channel.

13. The mowing apparatus of claim 5, wherein the mounting housing assembly comprises a connecting portion disposed within the mounting cavity, and a connection cavity in fluid communication with the cutting cavity and the inlet side of the impeller is formed in the connecting portion;
the battery pack is supported on the mounting housing adjacent to the connecting opening, the battery pack comprises a heat dissipation inlet and a heat dissipation outlet in fluid communication with inside of the battery pack, and the heat dissipation outlet is fluidly communication with the connection cavity.

14. The mowing apparatus of claim 13, further comprising an air guiding housing disposed within the mounting cavity and an air guiding channel in fluid communication with the connecting cavity and the inlet side of the impeller, wherein:
the air guiding housing encloses the air guiding channel; or
the air guiding housing and the mounting housing assembly together enclose the air guiding channel.

15. The mowing apparatus of claim 5, wherein the housing assembly further comprises:
a positioning housing, wherein the control module is disposed within the positioning housing, and the positioning housing in fluid communication with the mounting cavity and the inlet side of the impeller.

16. The mowing apparatus of claim 15, wherein the housing assembly further defines an air guiding groove, and the air guiding groove communicates with the positioning housing and the inlet side of the impeller.

17. The mowing apparatus of claim 16, wherein the air guiding groove is formed on a side of the cutting housing assembly opposite the cutting cavity and in fluid communication with at least one of the mounting cavity or the supplemental air channel.

18. A mowing apparatus, comprising:
a housing assembly comprising an air inlet opening to outside, a grass-discharge channel, and a cutting cavity fluidly connected to both the air inlet and the grass-discharge channel; and
a cutting assembly disposed within the cutting cavity, comprising a first motor and a cutting blade coupled to the first motor;
wherein the grass-discharge outlet is configured to allow a first airflow and a supplemental airflow to pass therethrough, and wherein the first airflow and the supplemental airflow are configured to converge at a preset position, with paths of the supplemental airflow and the first airflow being at least partially different upstream of a convergence point.

19. The mowing apparatus of claim 18, wherein the first airflow is generated by rotation of the cutting blade, and the supplemental airflow is generated under driving by a second motor.

20. The mowing apparatus of claim 18, wherein the preset position is located at the grass-discharge outlet or upstream of the grass-discharge outlet.
